(19) United States
(12) Patent Application Publication
(10) Pub. No.: US 2008/0201121 A1
(43) Pub. Date: Aug. 21, 2008

(54) APPARATUS FOR COMPUTING A MANY-BODY PROBLEM

(76) Inventor: YUICHI YANO, Tokyo (JP)

Correspondence Address: NEC CORPORATION OF AMERICA, 6535 N. STATE HWY 161, IRVING, TX, 75039, US

(21) Appl. No.: 12/033,201

(22) Filed: Feb. 19, 2008

(30) Foreign Application Priority Data
Feb. 20, 2007 (JP) 2007-038766

(51) Int. Cl. G06F 17/10

(52) U.S. Cl. 703/2

(57) ABSTRACT

A many-body problem computing apparatus includes a coordinate storage unit for storing coordinates of the centers of gravity of residues which particles belong to, a gravity center distance computing unit for computing a distance between the coordinates of the center of gravity of a residue which a specific particle belongs to and the coordinates of the center of gravity of a residue which the other particles belong to, and a distance comparison unit for comparing the distance computed by the distance computing unit with a cut-off distance and giving instructions to compute a force or potential if the distance is less than the cut-off distance.

This application is based upon and claims the benefits of priority from Japanese Patent Application No. 2007-038766 filed on Feb. 20, 2007, the disclosure of which is incorporated herein in its entirety by reference.

### BACKGROUND OF THE INVENTION

1. Field of the invention

The present invention relates a method of computing a many-body problem and an apparatus for computing the many-body problem which are capable of efficient computation of forces or potentials in the molecular dynamics method.

2. Description of the Related Art

Japanese Laid-Open Patent Publication No. H8-285757 (hereafter, referred to as Patent Document 1) describes a kind of apparatus for computing many-body problem. The apparatus for computing a many-body problem according to Patent Document 1 has an addressing unit, a coordinate storage unit, a coordinate data selection unit, an inter-particle distance computing unit, an i-particle coordinate storage unit, a comparison unit, a cut-off distance storage unit, a storage unit for storing particle coordinates within a cut-off distance, and an addressing unit. Plural computers are used simultaneously to each compute a Coulomb force or potential acting between a certain particle, which differs for each computer, and the other particles. During this time, a particle coordinate list of the particles located at a distance smaller than a suitable cut-off distance from the certain particle is automatically created. On the basis of the list thus created, the computers simultaneously compute a van der Waals force or potential acting on the respective certain particles.

Another type of apparatus for computing a many-body problem is described in Japanese Laid-Open Patent Publication No. H9-251449 (hereafter, referred to as Patent Document 2). The apparatus for computing a many-body problem according to this prior art is designed such that a single entire particle coordinate storage unit is shared by plural computing units, and the coordinates are sequentially output upon address supply from an address supply unit. The coordinates thus output are used as arguments of a function together with a specific particle in each of the computing units. It is determined based on a function value obtained by the computation and a preset cut-off value whether or not the output coordinate is to be cut off. If the coordinate is determined not to be cut off, an address supplied from the address supply unit 74 is stored as required. The address supply unit then sequentially supplies the addresses stored in the respective computing units. The entire particle coordinate storage unit outputs coordinates of a particle corresponding to the supplied address. The computing unit computes a physical quantity of a specific particle based on the particle coordinates output by the entire particle coordinate storage unit 71.

Another prior art is disclosed in Japanese Laid-Open Patent Publication No. 2002-55970 (hereafter, referred to as Patent Document 3) as a method of computing with a high-accuracy and a large-scale and an apparatus therefor which are capable of computation at a practical computation cost. The method according to Patent Document 3 is a dynamic computing method in which a single molecule is treated as a single particle while using a potential function representing intermolecular interaction energy obtained by quantum chemistry computation as a function of a distance between the centers of gravity of the molecules.

Further, Japanese Laid-Open Patent Publication No. 2004-109053 (hereafter, referred to as Patent Document 4) discloses a method of predicting a binding site and an apparatus for predicting a binding site, in which data of spatial distances between amino acid residues in a tertiary structure of a protein or biologically active polypeptide is obtained based on amino acid sequence data of the protein or biologically active polypeptide (step SA-1), and the binding site is predicted by identifying electrostatically unstable amino acid residues according to the distance data and the charges of the amino acids (steps SA-2 to SA-4). Accordingly, it is made possible to predict a binding site at a high speed and high accuracy based on the amino acid sequence of the protein or biologically active polypeptide by utilizing the fact that the electrostatically unstable amino acid residues are apt to form a binding site.

According to the methods of computing a many-body problem, such as the molecular dynamics method described above, it is required to computate a total sum of forces or potentials acting between a specific particle in a system consisting of plural particles and the other particles to obtain the force or potential acting on the specific particle.

Further, this computation must be performed for all the particles contained in the system, resulting in an enormous amount of computation effort required.

Some conventional apparatus for computing a many-body problem, for example those described in Patent Documents 1 and 2, define a cut-off distance suitable for a required computation accuracy is defined as rc and compute forces or potentials only for particles located at a distance r that is equal to or smaller than rc from a specific particle. This computation method is referred to as the cut-off method. According to the cut-off method, those particles located at a distance r smaller than rc from an i-th specific particle are indicated with black spots while the other particle are indicated with white spots. Only those particles indicated with the black spots are used in computation for the i-th specific particle. However, when the cut-off is performed based on the inter-particle distance in this manner, it may happen that one of covalently bonded particles is used in the computation while the other is not. For example, only one of a pair of particles forming a dipole may be used in the computation. A dipole is composed of particles having positive and negative charges of a same value, and hence the total charge is zero. The force exerted by the dipole to the specific particle is small.

However, if only one of the pair of particles is used in the computation, a large force will act on the specific particle, leading to increased variation in energy. This may cause a problem of unstable computation. The variation in energy can be reduced and the computation can be stabilized by using all the particles forming dipoles or residues in the computation.

Accordingly, a method is proposed in which if a distance between the coordinates of the center of gravity of a residue which a specific particle belongs to and the coordinates of the center of gravity of a residue which other particles belong to is within a cut-off distance, all the particles belonging to the residue are used in the computation. This method is referred to as the residue-based cut-off.

The black and white spots illustrate the particles, and a residue is formed by the particles enclosed by the broken line. For example, the distance from the center of gravity of a residue B to the center of gravity of a residue A which the specific particle, or the i-particle belongs to is smaller than rc. Therefore, all the particles belonging to the residue B are used in the computation for the i-particle. On the other hand, since the distance from the center of gravity of a residue C to the center of gravity of the residue A is greater than rc, none of the particles belonging to the residue C is used in the computation for the i-particle.

The conventional apparatuses for computing the many-body problem are only able to use inter-particle distances for the cut-off purpose, and not able to use a distance between the coordinates of the centers of gravity of the residues which the particles belong to. Therefore, these apparatuses are not able to implement the residue-based cut-off method used in the molecular dynamics.

Thus, the conventional apparatuses are only able to use inter-particle distances for the cut-off and not able to compute with the use of the residue-based cut-off method.

### SUMMARY OF THE INVENTION

It is an object of the present invention to provide a method of computing a many-body problem and an apparatus for computing the many-body problem enabling the use of the residue-based cut-off.

According to one aspect of the present invention, there is provided a method of computing a many-body problem which includes a step of computing a force or potential acting on a specific particle in a system consisting of plural particles. In the method, the step of computing the force or potential is conducted only on a particle pair of a residue the center of gravity of which is located at a coordinate distance less than a cut-off distance.

In the aspect of the present invention, it is preferable that the residue is an amino acid forming a protein.

In the aspect of the present invention, it is also preferable that the method further includes using a coordinate storage device. The coordinate storage device includes:

a first coordinate storage portion for storing the coordinates (x, y, z) of the particles in the system;

a second coordinate storage portion for storing the coordinates (Rxi, Ryi, Rzi) of the centers of gravity of residues which the particles in the system belong to;

a third coordinate storage portion for storing the coordinates of a specific particle, or an i-particle; and

a fourth coordinate storage portion for storing the coordinates of the center of gravity of the residue which the i-particle belongs to.

In the method, the step of using the coordinate storage device includes:

computing an inter-particle distance based on the coordinates of the j-particle and the coordinates of the i-particle in the third coordinate storage portion,

computing a distance between the centers of gravity of the residues based on the coordinates of the j-particle and the coordinates of the center of gravity of the i-particle in the third coordinate storage portion to be compared with the cut-off distance;

making zero the computation result of the inter-particle distance when the distance between the coordinates of the centers of gravity is greater than the cut-off distance; and

computing a force or potential is computed based on the inter-particle distance obtained as the result of computation when the distance between the coordinates of the centers of gravity is smaller than the cut-off value.

In the aspect of the present invention, it is more preferable that the method further includes designating a first and second addresses for designating the respective addresses of the first storage portion and the second storage portion, selecting an address according to the designation of the first and second addresses.

In the present invention, it is also more preferable that the selecting the address includes:

when a particle write signal is activated from an external device,

reading out the coordinates of the specific particle, or the i-particle selected by the designation of the second address from the first coordinate storage portion writing the same in the third coordinate storage portion, and

reading out the coordinates of the center of gravity of the residue which the i-particle belongs to from the second coordinate storage portion and writing the same in the fourth coordinate storage portion; and

when the particle write signal is inactivated from the external device,

selecting an initial address of the j-particle to be computed with the i-particle set by the designation of the first address,

reading out the coordinates of the j-particle from the first coordinate storage portion and output for the distance computation,

reading out the coordinates of the center of gravity of the residue which the j-particle belongs to from the second coordinate storage portion, and

outputting for the computation of the gravity center distance.

In the method of the present invention it is also more preferable that the designating the first address includes: incrementing the address by one on each clock pulse, whereby the computation is sequentially conducted on the j-particles, and upon completion of the computation for all the j-particles in the system; setting the initial j-particle address; and incrementing the designation of the second address by one so that sequential computation is conducted on the next i-particle.

According to another aspect of the present invention, there is provided an apparatus for computing a many-body problem which includes:

a coordinate storage unit for storing coordinates of the centers of gravity of residues which particles belong to;

a gravity center distance computing unit for computing a distance between the coordinates of the center of gravity of a residue which a specific particle belongs to and the coordinates of the center of gravity of a residue which other particles belong to; and

a distance comparison unit for comparing the distance obtained by the gravity center distance computing means with a cut-off distance and giving instructions to compute a force or potential if the distance is less than the cut-off distance.

In the aspect of the present invention, it is preferable that the residue is an amino acid forming a protein.

In the aspect of the present invention, it is preferable that the apparatus further includes:

a first coordinate storage unit for storing the coordinates of the particles in the system;

a second coordinate storage unit for storing the coordinates of the centers of gravity of residues which the particles in the system belong to;

a third coordinate storage unit for storing the coordinates of a specific particle, or an i-particle;

a fourth coordinate storage unit for storing the coordinates of the center of gravity of the residue which the i-particle belongs to;

a first distance computing unit for computing an inter-particle distance;

a second distance computing unit for computing a distance between the centers of gravity of the residues;

a distance comparison unit for comparing the cut-off distance; and

a computing unit for computing a force or potential based on the inter-particle distance computed by the first distance computing means.

In the apparatus, it is also preferable that the coordinate storage unit is used as second storage means, while the gravity center distance computing unit is used as the second distance computing unit;

the first coordinate storage unit sequentially stores the coordinates (x, y, z) of the particles in the system;

the second coordinate storage unit stores the coordinates of the centers of gravity (Rx, Ry, Rz) of the residues which the particles belong to in the same sequence as the first coordinate storage unit;

the coordinates (xi, yi, zi) of a specific particle, or an i-particle are read out from the first coordinate storage means and written in the third storage means, while the coordinates of the center of gravity (Rxi, Ryi, Rzi) of the residue which the i-particle belongs to are read out from the second coordinate storage unit and written in the fourth coordinate storage unit;

the second distance computing unit computes a distance from the coordinates of the center of gravity of the residue which the i-particle belongs to stored in the fourth coordinate storage unit based on the coordinates of the center of gravity of the residue which the j-particle belongs to;

the coordinates of the j-particle are used by the first distance computing unit to compute a distance from the coordinates of the i-particle stored in the third coordinate storage unit;

the distance comparison unit compares the distance between the coordinates of the centers of gravity with the cut-off distance, and outputs a signal to set the output of the computing unit to zero when the distance is greater than the cut-off distance, and activates the output of the computing unit to compute a force or potential based on the inter-particle distance computed by the first distance computing unit when the distance is smaller than the cut-off distance.

In the aspect of the present invention, it is more preferable that the apparatus further includes:

first and second addressing units for designating respective addresses of the first and second coordinate storage units; and

an address selection unit for selecting an address of the first and second addressing units. In the apparatus, when a particle write signal from an external device is activated, the address selection unit reads out the coordinates (xi, yi, zi) of a specific particle, or an i-particle selected by the second addressing unit from the first coordinate storage unit and writes the same in the third storage unit, while reads out the coordinates of the center of gravity (Rxi, Ryi, Rzi) of the residue which the i-particle belongs to from the second coordinate storage unit and writes the same in the fourth coordinate storage unit;

when the particle write signal is inactivated from an outer device, the address selection means selects the initial address of the j-particle to be computed with the i-particle set in the first address selection unit, and reads out the coordinates of the j-particle from the first coordinate storage unit to output the same to the first distance computing unit, while reads out the coordinates of the center of gravity of the residue which the j-particle belongs to from the second coordinate storage unit to output the same to the second distance computing unit;

the first addressing unit increments its address by one on each clock pulse to sequentially conduct computations for the j-particles and, upon completing the computations for all the j-particles in the system, sets the initial j-particle address in the first addressing unit, and the second addressing unit increments its address by one to sequentially conduct computations for the next i-particle.

### BRIEF DESCRIPTION OF THE DRAWINGS

FIG. 1 is a diagram showing configuration of a many-body problem computing apparatus according to an example of prior art;

FIG. 2 is a diagram showing configuration of a many-body problem computing apparatus according to another example of prior art;

FIG. 3 is a flowchart illustrating a method of finding a binding site of a protein based on one piece of sequence information according to prior art;

FIG. 4 is a diagram for explaining a “cut-off”;

FIG. 5 is a diagram for explaining a “residue-based cut-off”;

FIG. 6 is a block diagram showing a many-body problem computing apparatus according to an embodiment of the present invention;

FIG. 7 is a block diagram showing a many-body problem computing apparatus according to a second embodiment of the present invention; and

FIG. 8 is a diagram showing correspondence relation between the coordinate storage unit and the coordinate storage unit shown in FIG. 7.

### DESCRIPTION OF THE PREFERRED EMBODIMENTS

Prior to description of embodiments of the present invention, description will be given on conventional apparatuses for computing a many-body problem in order to facilitate understanding of the present invention.

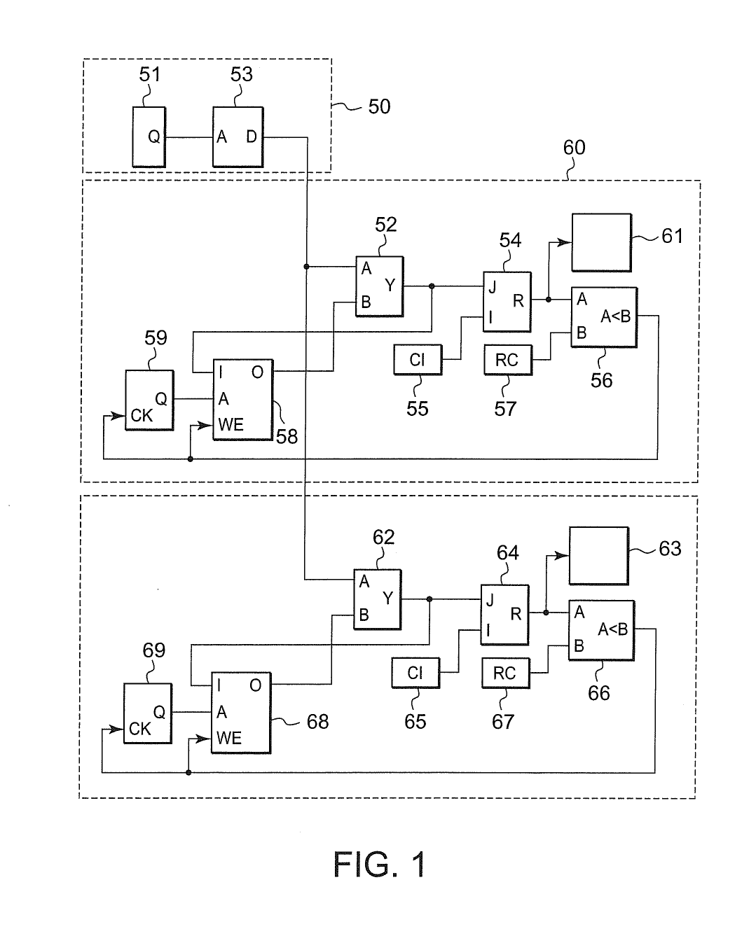

Referring to FIG. 1, the apparatus for computing the many-body problem disclosed in Patent Document 1 has an addressing unit 51, a coordinate storage unit 53, coordinate data selection units 52 and 62, inter-particle distance computing units 54 and 64, i-particle coordinate storage units 55 and 65, comparison units 56 and 66, cut-off distance storage units 57 and 67, particle coordinate storage units 58 and 68 for storing coordinates of particles located at a distance less than a cut-off distance, and addressing units 59 and 79. According to this prior art, plural of computers are used simultaneously to compute Coulomb forces or potentials acting between a certain particle, which differs for each computer, and the other particles. During this computation, a list of coordinates of particles located at a distance less than an appropriate cut-off distance from the certain particle is created automatically, and the computers simultaneously compute van der Waals forces or potentials acting on the respective certain particles based on the list.

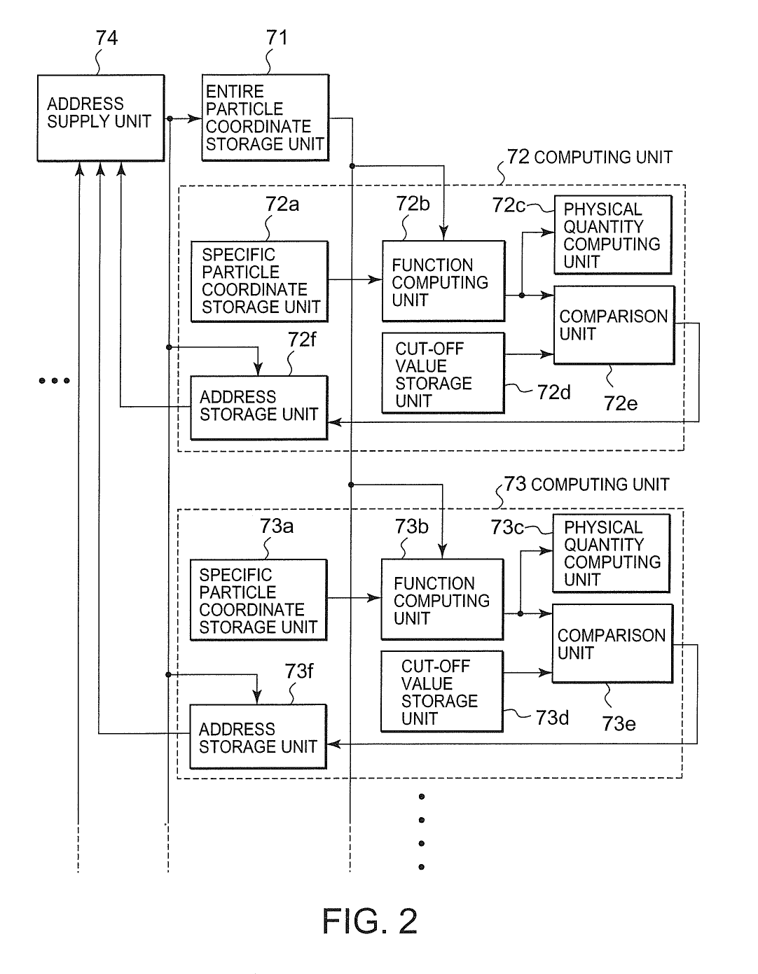

Referring to FIG. 2, the apparatus for computing the many-body problem disclosed in Patent Document 2 has a single entire particle coordinate storage unit 71 is shared by a plurality of computing units 72 and 73, and all the coordinates are output sequentially by supply of addresses from an address supply unit 74. The coordinate thus output is used as an argument of a certain function together with a specific particle in each of the computing units. It is then determined whether the 25 output coordinate is to be cut off or not based on the value of the function obtained by the computation and a preset cut-off value. If it is determined that the coordinate is not to be cut off, an address supplied by the address supply unit 74 is stored as needed. The address supply unit 74 then sequentially supplies addresses stored in the computing units 72 and 73. The entire particle coordinate storage unit 71 outputs coordinates of a particle corresponding to the supplied address. The computing units 72 and 73 each computes a physical quantity of the specific particle based on the coordinates of the particle output by the entire particle coordinate storage unit 71.

The method of computing and apparatus for computing with a high-accuracy and a large-scale, are capable of computation at a practical computation cost proposed in Patent Document 3 and relate to a dynamic computing method in which a single molecule is treated as a single particle while using a potential function representing intermolecular interaction energy obtained by quantum chemistry computation as a function of a distance between the centers of gravity of the molecules. Detailed description thereof will be omitted here.

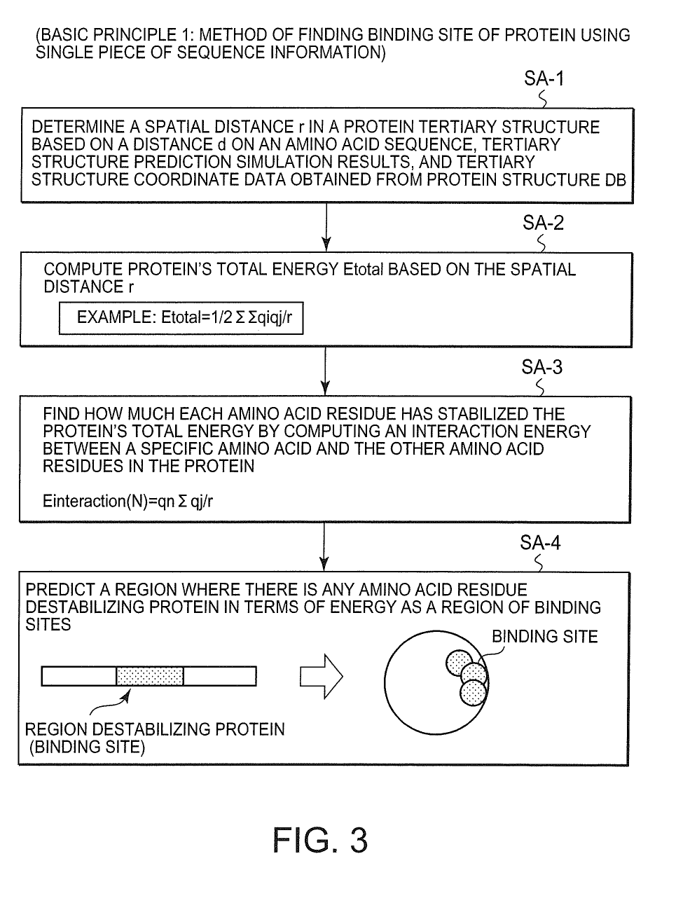

As seen by referring to FIG. 3, according to the binding site prediction method and apparatus disclosed in Patent Document 4, spatial distance data between amino acid residues in a tertiary structure of a protein or biologically active polypeptide is obtained based on amino acid sequence data of the protein or biologically active polypeptide(step SA-1), and a binding site is predicted by specifying an electrostatically unstable amino acid residue on the basis of the distance data and charges of the amino acids (step SA-2 to SA-4). Thus, the binding side can be predicted rapidly and accurately on the basis of the amino acid sequence data of the protein or biologically active polypeptide by utilizing the fact that an amino acid residue possibly electrostatically unstable is apt to form a binding site.

As described above, according to the conventional method of computing the many-body problem, such as a molecular dynamics method, a force or potential acting on a specific particle in a system consisting of plural particles must be computed as a total sum of forces or potentials acting between the specific particle and all of the other particles in the system.

Further, this computation must be done for all the particles in the system, resulting in an enormous amount of computation effort required.

In order to solve such problems, some of the conventional apparatus for computing the many-body problem, for example those described in Patent Documents 1 and 2, employ a technique referred to as “cut-off” in which an appropriate cut-off distance rc is defined according to a required computation accuracy, and forces or potentials are computed only for particles which are located at a distance r less than the distance rc from a specific particle.

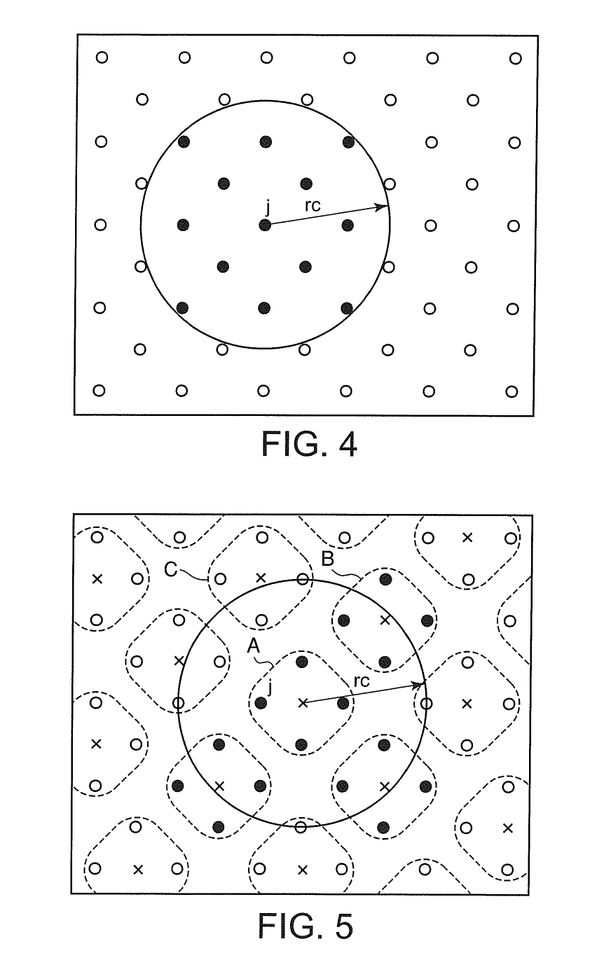

Referring to FIG. 4, black and white spots indicate particles. Those particles located at a distance r less than rc from a specific i-th particle are indicated by the black spots, while the other particles are indicated by the white spots. Only those particles indicated by the black spots are used in the computation for the specific i-th particle.

However, when the cut-off is performed based on the inter-particle distances in this manner, it may happen that one of covalent bonded particles is used in the computation while the other is not. For example, only one of a pair of particles forming a dipole may be used in the computation. A dipole is composed of particles having positive and negative charges of a same value, and hence the total charge thereof is zero. The force exerted by the dipole to the specific particle is small.

However, if only one of the pair of particles is used in the computation, a large force will act on the specific particle, leading to increased variation in energy. This may cause a problem of unstable computation. This problem can be solved by using all the particles forming dipoles or residues in the computation to reduce the variation in energy and to stabilize the computation.

Accordingly, a method is proposed according to which if a distance between the coordinates of the center of gravity of a residue which a specific particle belongs to and the coordinates of the center of gravity of a residue which the other particles belong to is less than a cut-off distance, all the particles belonging to the residue are used in the computation.

This method is referred to as residue-based cut-off.

Referring to FIG. 5 illustrating the residue-based cut-off, black and white spots indicate particles, while a residue is formed by particles enclosed by a broken line. An x-mark in the figure indicates the center of gravity of each residue. For example, the center of gravity of a residue B is located at a distance less than rc from the center of gravity of a residue A which a specific particle, or an i-particle belongs to. Therefore, all the particles belonging to the residue B are used in computation for the i-particle. On the other hand, the center of gravity of a residue C is located at a distance greater than rc from the center of gravity of the residue A. Therefore, none of the particles belonging to the residue C is used in the computation for the i-particle.

Description will now be made as regards preferred embodiments of the present invention with reference to the accompanying drawings.

The present invention provides a method of computing a many-body problem and an apparatus for computing the mainbody problem which are able to compute a force or potential acting on a specific particle in a system consisting of a plurality of particles. In the method and apparatus, the computation of the force or potential is performed only on particle pairs belonging to a residue (amino acid forming a protein) located at distance given by the coordinates of the center of gravity thereof less than a cut-off distance.

Description will be made more specifically.

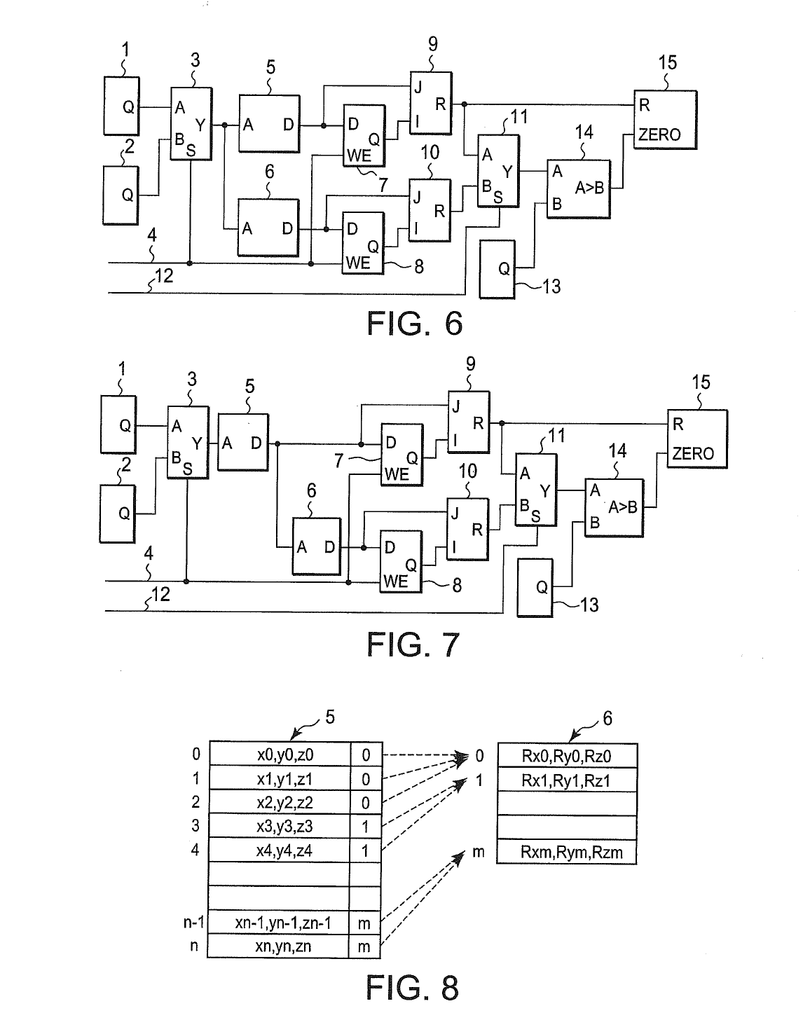

FIG. 6 is a block diagram showing an apparatus for computing a many-body problem according to an embodiment of the present invention. As shown in FIG. 6, the apparatus includes a coordinate storage unit 6 for storing coordinates of the centers of gravity of residues which particles belong to, a distance computing unit 10 for computing a distance between the coordinates of the center of gravity of a residue which a specific particle belongs to and the coordinates of the center of gravity of the residues which the other particles belong to, and a distance comparison unit 14 for comparing the distance obtained by the distance computing unit and the cut-off distance and giving instructions to compute a force or potential if the distance is less than the cut-off distance.

More specifically, the apparatus according to the present invention shown in FIG. 6 has a first and second addressing units 1 and 2, an address selection unit 3, a signal generation unit (not shown) provided in an external device for generating a particle write signal 4, a first coordinate storage unit 5, a second coordinate storage unit 6, a third coordinate storage unit 7, a fourth coordinate storage unit 8, a first distance computing unit 9, a second distance computing unit 10, a distance selection unit 11, a signal generation unit (not shown) provided in an external device for generating a distance selection signal 12, a distance storage unit 13, a distance comparison unit 14, and a computing unit 15.

The first addressing unit 1 and the second addressing unit 2 designate addresses of the first coordinate storage unit 5 and the second coordinate storage unit 6 to be described later. The address selection unit 3 selects an address from the first addressing unit 1 and the second addressing unit 2. The first coordinate storage unit 5 stores coordinates of particles in a system. The second coordinate storage unit 6 stores coordinates of the centers of gravity of residues which the particles in the system belong to.

The particle write signal 4 from the external device activates the selection signal from the address selection unit 3, and activates a write signal to the third coordinate storage unit 7 and the fourth coordinate storage unit 8.

The third coordinate storage unit 7 stores coordinates of a specific particle, or an i-particle. The fourth coordinate storage unit 8 stores coordinates of the center of gravity of a residue which the i-particle belongs to. The first distance computing unit 9 computes an inter-particle distance. The second distance computing unit 10 computes a distance between the centers of gravity of residues.

The distance selection unit 11 selects a distance from the second distance computing unit 10. The distance selection signal 12 from the external device activates a selection signal from the distance selection unit 11. The distance storage unit 13 stores a cut-off distance. The distance comparison unit 14 compares the distance selected by the distance selection unit 11 with the cut-off distance stored in the distance storage unit 13.

The computing unit 15 computes a force based on the inter-particle distance computed by the first distance computing unit 9.

Description will be made as regards an operation of the apparatus according to the embodiment of the present invention.

It is assumed that the coordinates (x, y, z) of particles in a system by a device not shown in the drawing have sequentially been written in the first coordinate storage unit 5, and the coordinates of the centers of gravity (Rx, Ry, Rz) of the residues, which the particles belong to in the same sequence as in the first coordinate storage unit 5, have been written in the second coordinate storage unit 6.

The particle write signal 4 from the external device activates the selection signal from the address selection unit 3, and activates a write signal to the third coordinate storage unit 7 and the fourth coordinate storage unit 8.

Firstly, the selection signal and the write signal are activated by the particle write signal 4 from the external device (not shown). An address is selected by the address selection unit 3 from those set in the second addressing unit 2, and the coordinates (xi, yi, zi) of the specific particle, or the i-particle are read out from the first coordinate storage unit 5 and written in the third coordinate storage unit 7. At the same time, the coordinates of the center of gravity (Rxi, Ryi, Rzi) of the residue which the i-particle belongs to are read out from the second coordinate storage unit 6 and written in the fourth coordinate storage unit 8.

Subsequently, the particle write signal 4 from the external device (not shown) is inactivated, and a first address of a j-particle to be used in computation with the i-particle is selected by the address selection unit 3 from those set in the first addressing unit 1. The coordinates of the j-particle are read out from the first coordinate storage unit 5, and the coordinates of the center of gravity of the residue which the j-particle belongs to are read out from the second coordinate storage unit 6. A distance is computed by the second distance computing unit 10 between the coordinates of the center of gravity of the residue which the j-particle belongs to and the coordinates of the center of gravity of the residue which the i-particle belongs to stored in the fourth coordinate storage unit 8.

On the other hand, a distance is computed by the first distance computing unit 9 between the coordinates of the j-particle and the coordinates of the i-particle stored in the third coordinate storage unit 7. The distance selection signal 12 from the external device (not shown) activates the selection signal, and a distance of the coordinates of the center of gravity of the residue computed by the second distance computing unit 10 is selected by the distance selection unit 11. The distance is then compared by the distance comparison unit 14 with the cut-off distance set in the distance storage unit 13 in response to a signal from the external device (not shown), and the output of the distance comparison unit 14 is activated if the distance is greater than the cut-off distance.

When the output of the distance comparison unit 14 is activated, the zero input of the computing unit 15 is activated so that the computation result of the force is always zero.

When the zero input of the computing unit 15 is not activated, the force or potential is computed based on the inter-particle distance computed by the first distance computing unit 9.

The first addressing unit 1 is formed, for example, by an up-counter, which increments its address by one on each clock pulse to sequentially conduct computations for the j-particles. Upon completing computation for all the j-particles in the system, the first j-particle address is set in the first addressing unit 1, and the second addressing unit 2 formed, for example. by an up-counter is incremented by one to conduct computation for the next i-particle.

The description so far relates to a case in which the cut-off is carried out at a distance given by the coordinates of the center of gravity of a residue which each particle belongs to. When the distance selection unit 12 is inactivated by a selection signal from the external device (not shown), the distance selection unit 11 selects the inter-particle particle distance computed by the first distance computing unit 9, whereby the cut-off can be carried out based on the distance given by the particle coordinates.

According to the first embodiment of the present invention as described above, the computation using the residue-based cut-off is enabled by the provision of the storage unit for storing coordinates of the centers of gravity of residues which the particles belong to, the computing unit for computing a distance given by the coordinates of the center of gravity, the unit for comparing the distance given by the coordinates of the center of gravity with the cut-off distance and giving instruction to compute a force or potential if the distance is less than the cut-off distance.

According to the first embodiment of the present invention, the computation using the cut-off based on the inter-particle distance is also enabled by the provision of the selection unit for selecting a distance given by the coordinates of the center of gravity of a residue or a distance given by the particle coordinates as an input of the unit for giving instructions to compute a force or potential.

Referring to FIG. 7 showing an apparatus for computing a many-body problem according to a second embodiment of the present invention, the configuration of the second embodiment is basically the same as that of the first embodiment except that the first coordinate storage unit 5 is connected to the second coordinate storage unit 6 in series instead of in parallel. This change produces further improvement in the storage unit for storing coordinates of the centers of gravity of residues which particles belong to.

Specifically, the coordinate storage unit 6 for storing coordinates of the centers of gravity of residues which particles belong to is connected to the coordinate storage unit 5 for storing the coordinates of the particles. The coordinate storage unit 5 for storing the coordinates of the particles stores serial numbers of the residues which the particles belong to in addition to the coordinates of the particles. The coordinate storage unit 6 sequentially stores the coordinates of the centers of gravity of the residues. According to the serial number of the residue which the particle belongs to read out from the coordinate storage unit 5, the coordinates of the residue which the particle belongs to are read out from the coordinate storage unit 6.

According to the second embodiment as described above, the coordinate storage unit 6 is not required to store the coordinates of the centers of gravity of the residues for all the particles, but may store the coordinates of the center of gravity of only the pertinent residues. Since a residue is usually composed of a plurality of particles, the storage capacity required for the coordinate storage unit 6 can be reduced.

FIG. 8 is a diagram illustrating correspondence relation between the coordinate storage unit 5 and the coordinate storage unit 6 shown in FIG. 7. The left side of FIG. 8 shows the coordinate storage unit 5 for storing the coordinates of the particles and the serial numbers of the residues which the particles belong to, while the right side shows the coordinate storage unit 6 for storing the coordinates of the centers of gravity of the residues. When it is assumed, for example, that residues are each composed of four particles on average, a quarter of the storage capacity of the coordinate storage unit 5 will suffice as the capacity of the coordinate storage unit 6.

It is obvious that the second embodiment of the present invention achieves the same effects as those of the first embodiment.

The present invention as described above provides a many-body problem computing method and apparatus capable of computation using the residue-based cut-off.

As described above, the method of computing a many-body problem and an apparatus for computing the many-body problem according to the present invention are applicable to special-purpose computers for computing forces or potentials in the molecular dynamics method.

What is claimed is:

1. A method of computing a many-body problem comprising a step of computing a force or potential acting on a specific particle in a system consisting of plural particles, wherein the step of computing the force or potential is conducted only on a particle pair of a residue the center of gravity of which is located at a coordinate distance less than a cut-off distance.

2. The method according to claim 1, wherein the residue is an amino acid forming a protein.

3. The method according to claim 1, further comprising a step of using a coordinate storage device, the coordinate storage device comprising:
a first coordinate storage portion for storing the coordinates (x, y, z) of the particles in the system;
a second coordinate storage portion for storing the coordinates (Rxi, Ryi, Rzi) of the centers of gravity of residues which the particles in the system belong to;
a third coordinate storage portion for storing the coordinates of a specific particle, or an i-particle; and
a fourth coordinate storage portion for storing the coordinates of the center of gravity of the residue which the i-particle belongs to,
wherein the step of using the coordinate storage device comprises:
computing an inter-particle distance based on the coordinates of the j-particle and the coordinates of the i-particle in the third coordinate storage portion,
computing a distance between the centers of gravity of the residues based on the coordinates of the j-particle and the coordinates of the center of gravity of the i-particle in the third coordinate storage portion to be compared with the cut-off distance;
making zero the computation result of the inter-particle distance when the distance between the coordinates of the centers of gravity is greater than the cut-off distance; and
computing a force or potential is computed based on the inter-particle distance obtained as the result of computation when the distance between the coordinates of the centers of gravity is smaller than the cut-off value.

4. The method according to claim 3, further comprising:
designating a first and second addresses for designating the respective addresses of the first storage portion and the second storage portion ; and
selecting an address according to the designation of the first and second addresses, wherein the selecting the address includes:
when a particle write signal is activated from an external device,
reading out the coordinates of the specific particle, or the i-particle selected by the designation of the second address from the first coordinate storage portion writing the same in the third coordinate storage portion, and
reading out the coordinates of the center of gravity of the residue which the i-particle belongs to from the second coordinate storage portion and writing the same in the fourth coordinate storage portion ; and
when the particle write signal is inactivated from the external device,
selecting an initial address of the j-particle to be computed with the i-particle set by the designation of the first address,
reading out the coordinates of the j-particle from the first coordinate storage portion and output for the distance computation,
reading out the coordinates of the center of gravity of the residue which the j-particle belongs to from the second coordinate storage portion, and
outputting for the computation of the gravity center distance, and wherein the designating of the first address includes:
incrementing the address by one on each clock pulse, whereby the computation is sequentially conducted on the j-particles, and upon completion of the computation for all the j-particles in the system;
setting the initial j-particle address; and
incrementing the designation of the second address by one so that sequential computation is conducted on the next i-particle.

5. An apparatus for computing a many-body problem comprising:
coordinate storage means for storing coordinates of the centers of gravity of residues which particles belong to;
gravity center distance computing means for computing a distance between the coordinates of the center of gravity of a residue which a specific particle belongs to and the coordinates of the center of gravity of a residue which other particles belong to; and
distance comparison means for comparing the distance obtained by the gravity center distance computing means with a cut-off distance and giving instructions to compute a force or potential if the distance is less than the cut-off distance.

6. The apparatus according to claim 5, wherein the residue is an amino acid forming a protein.

7. The apparatus according to claim 5, further comprising:
first coordinate storage means for storing the coordinates of the particles in the system;
second coordinate storage means for storing the coordinates of the centers of gravity of residues which the particles in the system belong to;
third coordinate storage means for storing the coordinates of a specific particle, or an i-particle;
fourth coordinate storage means for storing the coordinates of the center of gravity of the residue which the i-particle belongs to;
first distance computing means for computing an inter-particle distance;
second distance computing means for computing a distance between the centers of gravity of the residues;
distance comparison means for comparing the cut-off distance; and
computing means for computing a force or potential based on the inter-particle distance computed by the first distance computing means, wherein:
the coordinate storage means is used as second storage means, while the gravity center distance computing means is used as second distance computing means;
the first coordinate storage means sequentially storing the coordinates (x, y, z) of the particles in the system;
the second coordinate storage means storing the coordinates of the centers of gravity (Rx, Ry, Rz) of the residues which the particles belong to in the same sequence as the first coordinate storage means;
the coordinates (xi, yi, zi) of a specific particle, or an i-particle being read out from the first coordinate storage means and written in the third storage means, while the coordinates of the center of gravity (Rxi, Ryi, Rzi) of the residue which the i-particle belongs to are read out from the second coordinate storage means and written in the fourth coordinate storage means;
the second distance computing means computing a distance from the coordinates of the center of gravity of the residue which the i-particle belongs to stored in the fourth coordinate storage means based on the coordinates of the center of gravity of the residue which the j-particle belongs to;
the coordinates of the j-particle being used by the first distance computing means to compute a distance from the coordinates of the i-particle stored in the third coordinate storage means;
the distance comparison means comparing the distance between the coordinates of the centers of gravity with the cut-off distance, and outputting a signal to set the output of the computing means to zero when the distance is greater than the cut-off distance, and activating the output of the computing means to compute a force or potential based on the inter-particle distance computed by the first distance computing means when the distance is smaller than the cut-off distance.

8. The apparatus according to claim 7, further comprising:
first and second addressing means for designating respective addresses of the first and second coordinate storage means; and
address selection means for selecting an address of the first and second addressing means, wherein:
when a particle write signal from an external device is activated, the address selection means reads out the coordinates (xi, yi, zi) of a specific particle, or an i-particle selected by the second addressing means from the first coordinate storage means and writes the same in the third storage means, while reads out the coordinates of the center of gravity (Rxi, Ryi, Rzi) of the residue which the i-particle belongs to from the second coordinate storage means and writes the same in the fourth coordinate storage means;
when the particle write signal from the external device is inactivated, the address selection means selects the initial address of the j-particle to be computed with the i-particle set in the first address selection means, and reads out the coordinates of the j-particle from the first coordinate storage means to output the same to the first distance computing means, while reads out the coordinates of the center of gravity of the residue which the j-particle belongs to from the second coordinate storage means to output the same to the second distance computing means;
the first addressing means increments its address by one on each clock pulse to sequentially conduct computations for the j-particles and, upon completing the computations for all the j-particles in the system, sets the initial j-particle address in the first addressing means; and
the second addressing means increments its address by one to sequentially conduct computations for the next i-particle.

9. The apparatus according to claim 8, wherein the first coordinate storage means and the second coordinate storage means are connected to the address selection means in parallel to each other.

10. The apparatus according to claim 8, wherein the first coordinate storage means and the second coordinate storage means are connected to the address selection means in series.
